(19) United States
(12) Patent Application Publication
(10) Pub. No.: US 2026/0172346 A1
(43) Pub. Date: Jun. 18, 2026

(54) TECHNIQUES FOR OPTIMIZING ROUTING FOR DIRECT INTERNET ACCESS

(71) Applicant: Cisco Technology, Inc., San Jose, CA (US)

(72) Inventors: Pritam Baruah, Fremont, CA (US); Sampath Kumar Sthothra Bhasham, Santa Clara, CA (US); Avinash Shah, Pleasanton, CA (US); Arul Murugan Manickam, Mountain House, CA (US)

(21) Appl. No.: 19/074,150

(22) Filed: Mar. 7, 2025

Related U.S. Application Data
(60) Provisional application No. 63/733,715, filed on Dec. 13, 2024.

(51) Int. Cl. H04L 45/00

(52) U.S. Cl. CPC H04L 45/54

(57) ABSTRACT

Techniques are described herein for optimizing routing of network traffic to a DIA connection. In embodiments, the techniques may be performed by an edge device operating on a LAN and may comprise receiving an advertisement message from a second device, the advertisement message including an indication of at least one second Direct Internet Access (DIA) connection accessible from the second device and updating a local routing table to include the indication of the at least one second DIA connection. The techniques may then comprise receiving network traffic to be routed over an external network, upon determining that the first DIA connection is unavailable, selecting the at least one second DIA connection based on the information in the local routing table, and forwarding the network traffic to the second device.

### CROSS-REFERENCE TO RELATED APPLICATIONS

This application claims priority from U.S. Provisional Application No. 63/733,715, filed Dec. 13, 2024, the entire disclosure of which is incorporated herein by reference and for all purposes.

### TECHNICAL FIELD

The present disclosure relates generally to computer networks, and more particularly, to optimizing path routing to a direct internet access gateway.

### BACKGROUND

Software-defined wide area networks (SD-WANs) represent the application of software-defined networking (SDN) principles to WAN connections, such as connections using cellular networks, the Internet, and Multiprotocol Label Switching (MPLS) networks. The power of SD-WAN is the ability to provide consistent service level agreement (SLA) for important application traffic transparently across various underlying paths of varying transport quality and allow for seamless path selection based on path performance characteristics that can match application SLAs.

With the emergence of technologies such as Infrastructure as a Service (IaaS) and Software as a Service (SaaS), the resulting virtualization of services has led to a dramatic shift in the traffic loads of many large enterprises. Indeed, many SaaS services can now be reached in a typical deployment via a number of different network paths. However, network traffic related to such applications may have service level requirements that vary greatly. In such cases, it may be beneficial to reserve a dedicated network for traffic with high service level requirements while routing other network traffic over external networks in order to preserve resources.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 depicts a block diagram illustrating an example network deployment environment that may be implemented in accordance with at least some embodiments.

FIG. 2 depicts a block diagram illustrating an architecture in which network traffic received by an edge device may be routed to an external network in accordance with at least some embodiments.

FIG. 3A depicts a first block diagram illustrating exemplary network traffic routing that may occur under a first scenario.

FIG. 3B depicts a second block diagram illustrating exemplary network traffic routing that may occur under a second scenario.

FIG. 4A depicts a third block diagram illustrating exemplary network traffic routing that may occur under a third scenario.

FIG. 4B depicts a fourth block diagram illustrating exemplary network traffic routing that may occur under a fourth scenario.

FIG. 5 depicts a block diagram illustrating techniques for sending advertisement messages between different devices in accordance with some embodiments.

FIG. 6 depicts a block diagram illustrating implementation of a routing table that may be maintained locally by an edge device to make routing decisions in accordance with at least some embodiments.

FIG. 7 depicts a flow diagram of an example method to be used in optimally routing network traffic to a DIA connection in accordance with embodiments.

FIG. 8 is a schematic block diagram of an example computer network illustratively comprising nodes/devices, such as a plurality of routers/devices interconnected by links or networks, as shown.

FIG. 9 illustrates an example of network in greater detail, according to various embodiments.

FIG. 10 is a computing system diagram illustrating a configuration for a data center that can be utilized to implement aspects of the technologies disclosed herein.

FIG. 11 shows an example computer architecture for a server computer capable of executing program components for implementing the functionality described above.

### DESCRIPTION OF EXAMPLE EMBODIMENTS

### Overview

A first method according to the techniques described herein may include receiving, at a first edge device that maintains a first DIA connection, an advertisement message from a second device, the advertisement message including an indication of at least one second Direct Internet Access (DIA) connection accessible from the second device, updating a local routing table to include the indication of the at least one second DIA connection, and receiving network traffic to be routed over an external network. The method may further include upon determining that the first DIA connection is unavailable, selecting the at least one second DIA connection based on the information in the local routing table, and forwarding the network traffic to the second device.

Additionally, the techniques described herein may be performed by a system and/or device having non-transitory computer-readable media storing computer-executable instructions that, when executed by one or more processors, performs the method described above.

Additionally, the disclosure may be directed to a system comprising a first edge device configured to monitor a current status of a Direct Internet Access (DIA) connection, and upon detecting a change in the current status of the DIA connection, provide an advertisement message to a second edge device that includes information about the current status. The system may further include the second edge device configured to receive the advertisement message from the first edge device, update a local routing table to include the information about the current status, upon receiving network traffic directed to an external network, select the DIA connection based on the local routing table, and route the network traffic to the first edge device.

### Example Embodiments

This disclosure describes techniques that may be performed by a computing device (e.g., an edge device) acting as a network gateway between two or more networks (e.g., a Local Area Network (LAN) and a SD-WAN fabric). The computing device may be configured to route communications between one or more user devices connected to it via a first network (e.g., the LAN) and one or more applications (e.g., services) hosted by a service provider platform (e.g., a SaaS provider) accessible over a second network (e.g., the SD-WAN fabric or the Internet). To that end, the edge device may make a determination as to whether to route traffic over the SD-WAN network or alternatively to an external network such as the Internet.

In some embodiments, the disclosure provides techniques for optimizing routing of network traffic to a DIA connection when that network traffic is to be routed over an external network. Notably, an edge device may be in communication with both a SD-WAN as well as at least one external network. The edge network may be configured to route network traffic over either the SD-WAN or the external network based on attributes associated with the network traffic. For example, network traffic that is associated with relatively high service level agreement (SLA) requirements may need to be sent over the SD-WAN fabric whereas network traffic that is associated with relatively low SLA requirements can be sent over the external network, freeing up network resources.

In embodiments, each edge device operating on a Local Area Network (LAN) may maintain a local routing table that includes a number of entries related to DIA connections. In such embodiments, the local routing table may store an indication as to a current status of each of the DIA connections. For example, the local routing table may indicate whether each DIA connection accessible by the edge device is available or unavailable. In some cases, the local routing table may further include an indication of a cost or weight associated with each entry. In such cases, the entries within the local routing table may be ordered based on that cost (e.g., from lowest to highest).

Each time that a device (e.g., an edge device or a hub device) detects a change in status of a DIA connection that it maintains, it may generate an advertisement message to be sent to other edge devices. Each of those edge devices may then update information stored in its local routing table to indicate the current status. When an edge device receives traffic that is determined to be directed toward an external network (e.g., the Internet), that edge device may identify an optimal (e.g., having the lowest cost) and available DIA connection to which the network traffic should be routed based on information stored in the local routing table.

Embodiments of the disclosure provide for a number of advantages over conventional systems. For example, embodiments allow for an edge device to forward network traffic to an optimal DIA connection. This results in minimizing the overall resources needed to route that network traffic by reducing the amount of time/hops that the network traffic spends on the system, freeing up resources for network traffic associated with high SLA requirements.

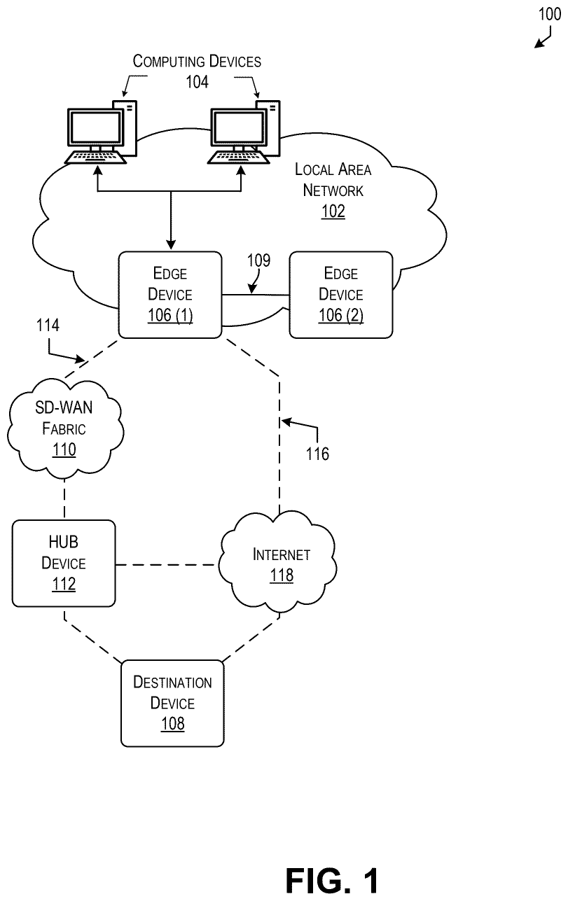

FIG. 1 depicts a block diagram illustrating an example network deployment environment 100 that may be implemented in accordance with at least some embodiments. In FIG. 1, a local area network (LAN) 102 may be accessed by a number of computing devices 104 at a geographic site. As depicted, a number of edge devices 106 (1 and 2) located at the edge of the geographic site may provide connectivity between the LAN 102 and one or more destination device 108 over a network connection (e.g., an SD-WAN fabric 110). For example, edge device 106 (1) may provide connectivity to the destination device 108 via paths (e.g., tunnels) across any number of networks that make up the environment 100. In embodiments, this allows clients using the LAN 102 of remote site to access services and applications (e.g., Office 365™, Dropbox™, etc.) served by the destination device 108.

An edge device 106 may include any electronic device that provides an ingress/egress point for a network (e.g., LAN 102). The edge device 106 may act as a router for a client user device. An example of an edge device 106 may include a router (e.g., an SD-WAN router), routing switch, integrated access device, multiplexer, or any other suitable device. The edge device 106 may include one or more processors and a memory that stores computer executable instructions for implementing at least a portion of the functionality described herein.

Where multiple edge devices operate on a single LAN 102, such as the depicted edge devices 106 (1) and 106 (2), at least one communication connection may be maintained between each of those edge devices. For example, a DIA interconnect 109 connection may be maintained between each of the edge devices, such that network traffic determined to be directed to an external network can be transmitted over the DIA interconnect 109 to another edge device to be routed to the external network.

The SD-WAN fabric 110 may be implemented across a number of computing devices each acting as nodes in the SD-WAN fabric 110. The computing devices making up the SD-WAN fabric 110 may centralized or clustered in a single location or may be geographically distributed throughout one or more regions. Overseeing the operations of the SD-WAN fabric 110 may be an SDN controller. In general, an SDN controller may comprise one or more devices configured to provide a supervisory service, typically hosted in the cloud, to the SD-WAN fabric 110 and/or one or more SD-WAN service points. For instance, an SDN controller may be responsible for monitoring the operations thereof, promulgating policies (e.g., security policies, etc.), installing or adjusting IPsec routes/tunnels between LAN 102 and remote destinations such as a regional hub device 112.

As would be appreciated, the environment 100 may allow for the use of a variety of different pathways between an edge device 106 in communication with a computing device 104 and destination device 108 depending upon where that destination device is located. For example, the edge device 106 may include, or may be in communication over a first path 114 with, a router configured to route communications over the SD-WAN fabric 110 to a hub device 112, which may in turn route communications to a destination device 108. In a second example, at least one second path 116 may traverse the Internet 118 (or any other suitable external network. In such cases, the edge device 106 may maintain at least one Direct Internet Access (DIA) connection to connect to the Internet 118.

In embodiments, a first interface of the router may establish a first communication path (e.g., a tunnel) with a destination device 108 via a tunnel created within the SD-WAN fabric 110. Likewise, a second interface of the router may establish a backhaul path with the destination device 108 via an ISP that manages an external network (e.g., Internet 118). In some embodiments, the router may establish a third path via a private corporate network (e.g., an MPLS network) to a private data center or regional hub device 112 which, in turn, provides connectivity to the destination device 108 via another network, such as a second ISP.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN 102 to the destination device 108. Other deployments scenarios are also possible, such as using Colo, accessing the destination device 108 via Zscaler™ or Umbrella™ services, and the like.

As noted above, the dynamics of Internet traffic has changed dramatically in recent years, in part due to the proliferation of SaaS applications. Traditionally, network topologies would be computed using traffic matrices thanks to off-line research operational tools allowing for traffic engineering (e.g., using IP, MPLS, etc.). However, with the emergence of SaaS applications, many large networks are now embracing a SaaS model for their critical applications, such as Dropbox™, Office 365™, SAP™, and the like.

One of the consequences of the emergence of SaaS traffic is that SaaS traffic tends to use a number of paths that may themselves exhibit various characteristics/key performance indicators (KPIs) in terms of QoE (e.g., loss, delay, jitter, throughput, etc.), thus leading to a strong variation of SLAs and user satisfaction. Typically, this is dealt with by specifying static SLAs on a per application basis using templates. For instance, one SLA template may specify that a tunnel is eligible to carry traffic for a voice application if it exhibits loss <3%, delay <150 ms, etc.

For the above reasons, it becomes common for the in-house traffic that requires SLA requirements to be sent to an internal data center (e.g., hub device 112), to be routed to a destination device 108. However, traffic that is unrelated to critical applications, traffic directed to a destination device located in an external network (e.g., Internet 118), or traffic that does not necessarily need to meet certain service level agreement (SLA) requirements, may be routed by the edge device 106 (1) over the Internet 118 via a DIA connection.

The techniques introduced herein improve the application experience for a user by more optimally routing traffic to a DIA connection. Specifically, according to various embodiments, a device (e.g., edge device 106) receives advertisement messages from other edge devices (and more particularly other edge devices operating on the same LAN 102). The advertisement messages include an indication of a status associated with a DIA connection for that edge device as well as DIA status information related to other devices (e.g., hub device 112). In some cases, the information about DIA statuses may further include an indication of a cost associated with each of a number of paths. The edge device 106 (1) may, upon receiving such an advertisement message, update a table that it maintains to indicate a current status of various DIA connections. Upon receiving network traffic that is to be routed to a DIA connection (e.g., based on SLA requirements for the network traffic), the edge device can quickly identify the path to the closest (e.g., fewest hops) DIA connection based on the generated table. In embodiments, edge devices may be configured to generate and send advertisement messages each time that a change is detected in a status of a DIA connection. For example, an edge device may generate and send an advertisement message if it detects that its own DIA connection has been severed or restored or if the edge device receives another advertisement message from a different device indicating a change in DIA status.

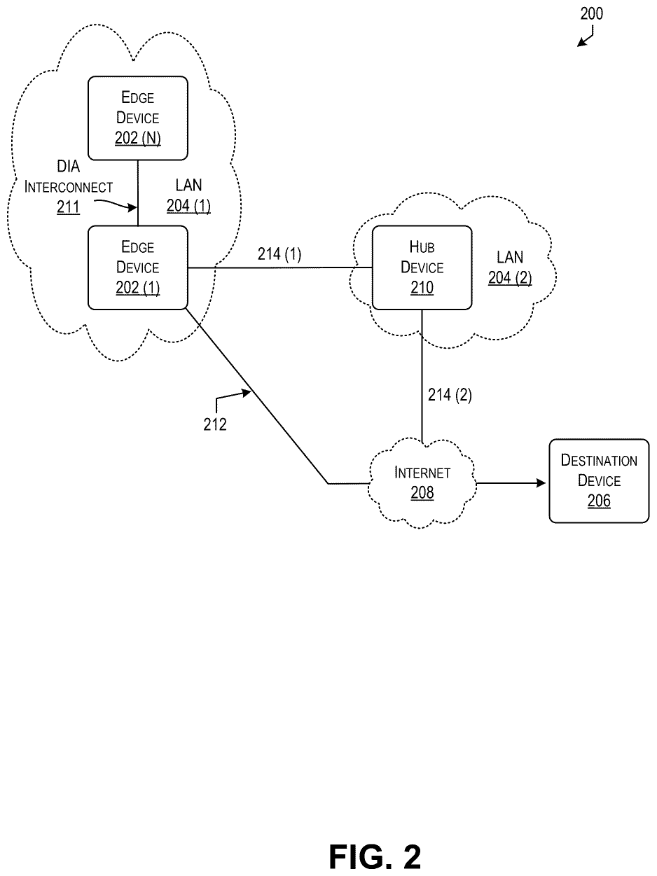

FIG. 2 depicts a block diagram illustrating an architecture in which network traffic received by an edge device may be routed to an external network in accordance with at least some embodiments. More particularly, the architecture 200 depicts interactions between a number of edge devices 202 (1 - N) operating on the edge of a LAN 204 to route network traffic to a receiving device 206 over an external network 208, or in the case that no local DIA exit is currently available, through a hub device 210. In embodiments, the hub device 210 may be communicated with via a SD-WAN fabric in communication with the number of edge devices 202 (1-N). Additionally, the hub device 210 may operate within a second LAN 204 (2) that is separate from the LAN 204 (1).

In embodiments, each of the number of edge devices 202 (1-N) operating on the edge of a LAN 204 (1) may be capable of routing communications to other edge devices operating on the same LAN 204 (1) via a DIA interconnect 211. The DIA interconnect 211 may be a dedicated communication tunnel over the LAN 204 (1) between two edge devices 202. Additionally, the edge devices 202 may be capable of communicating with the hub device 210 via a tunnel or other dedicated connection (e.g., over a SD-WAN fabric).

Upon receiving network traffic to be routed to a destination device (e.g., receiving edge device 204), an edge device 202 may make a determination about whether that network traffic should be routed over a dedicated network, such as a SD-WAN fabric, through a first path 214 (1 and 2), or alternatively over an external network, such as the Internet 208, through a second path 212. In embodiments, such a determination may be made based on a type of the network traffic to be routed as well as SLA requirements associated with that network traffic.

Upon determining that the network traffic should be routed over an external network (e.g., Internet 208), the edge device 202 may then identify an appropriate DIA connection over which that network traffic is to be routed to the external network while minimizing the network resources used to route that network traffic. In the most optimal scenario, the network traffic is routed over a DIA connection maintained by the edge device itself. However, in some cases, a DIA connection maintained by the edge device may be severed or unavailable. In such cases, the edge device 202 may be configured to route the network traffic to another edge device operating on the same local network as that edge device (e.g., via DIA interconnect 211) or to the hub device 210. Such routing decisions may be made based on information stored in a routing table maintained locally by the edge device.

In embodiments, an edge device 202 may route network traffic directed toward an external network to an optimal DIA connection based on information stored in a routing table maintained by the edge device 202. This routing table is populated with information received in advertisement messages received from other devices (e.g., other edge devices and/or a hub device).

A device, such as an edge device or hub device, may constantly monitor a status of its DIA connection in order to detect any change in status. For example, each device may attempt communication over the connection on a periodic basis. In some cases, the device may use a Bidirectional Forwarding Detection (BFD) protocol to detect a status of its DIA connection. BFD is a network protocol that monitors the health of tunnels between forwarding engines. The BFD protocol is enabled using a type of data structure called a Type-Length-Value (TLV).

The device may detect a change in status if the DIA connection becomes unavailable from being available or becomes unavailable from being available. Once the device has detected a change in status of its DIA connection, it may update the information included in its routing table to reflect that change in status. Each time that the routing table is updated, the device then generates an advertisement message that includes an indication of that current statuses indicated in the routing table. This advertisement message is then sent to a number of other devices in communication with that device.

When a first device receives an advertisement message from a second device, that first device updates its own routing table based on the received information. The first device may then generate a second advertisement message that is sent out to additional devices other than the second device, which subsequently update their own respective routing tables. In embodiments, in addition to information about DIA connections, the advertisement messages may include information about costs associated with each path to a respective DIA connection.

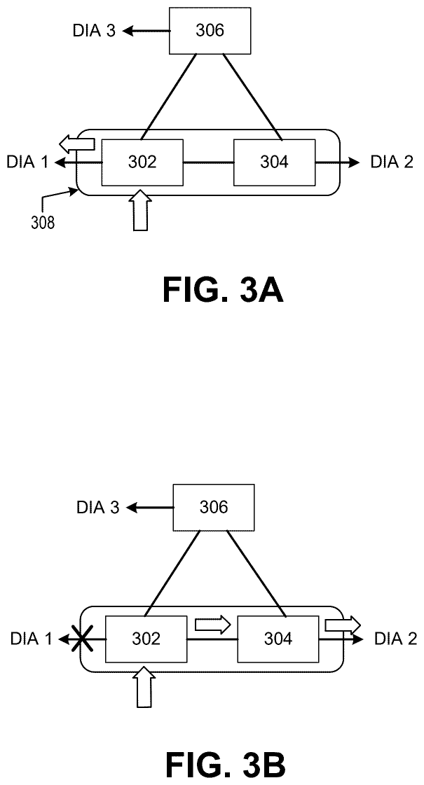

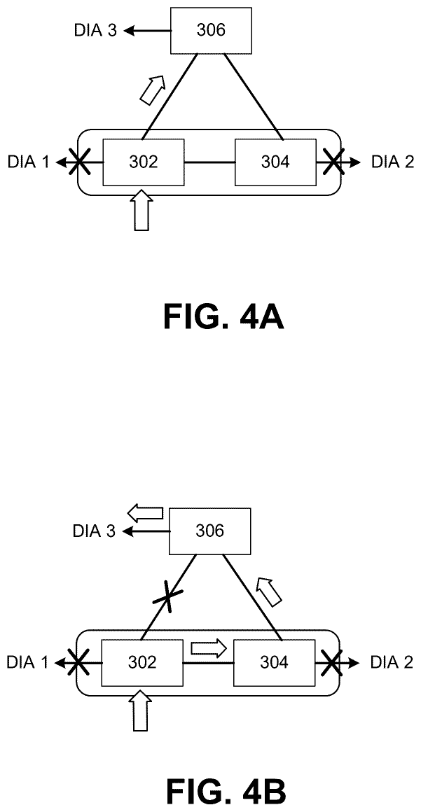

FIGS. 3A-3B and 4A-4B each depict examples of network traffic routing that may occur in embodiments of the system under different conditions. Each of the following figures depict interactions between multiple edge devices denoted as 302 and 304 as well as a hub device denoted as 306. In these figures, 302 maintains a first DIA connection (DIA 1), 304 maintains a second DIA connection (DIA 2), and 306 maintains a third DIA connection (DIA 3).

FIG. 3A depicts a first block diagram illustrating exemplary network traffic routing that may occur under a first scenario. In this first scenario, the first DIA connection (DIA 1) maintained by edge device 302 may be open and available. In other words, FIG. 3A represents a best-case scenario in which network traffic can be routed directly to an external network.

Upon receiving network traffic to be directed toward a receiving device, edge device 302 may first make a determination as to whether that network traffic should be routed over a dedicated connection under its control (e.g., a tunnel within a SD-WAN fabric) or instead over an external network connection (e.g., the Internet). Note that while service level requirements can be more easily controlled for network traffic routed over the dedicated connection, it may be necessary to route some portion of network traffic over the external network in order to reduce the load on that dedicated connection. Hence, an edge device may make a determination about whether to route network traffic over a dedicated connection based on service level agreement (SLA) requirements associated with that network traffic.

In this first scenario, upon receiving network traffic that the edge device 302 determines should be routed over an external network, edge device 302 would route that network traffic directly through DIA connection DIA 1.

FIG. 3B depicts a second block diagram illustrating exemplary network traffic routing that may occur under a second scenario. In this second scenario, the first DIA connection (DIA 1) maintained by edge device 302 may be currently unavailable. Additionally, the second DIA connection (DIA 2) maintained by edge device 304 as well as the third DIA connection (DIA 3) maintained by hub device 306 are both open and available.

Upon receiving network traffic to be directed toward a receiving device, and upon detecting that DIA connection DIA 1 is currently down, edge device 302 may consult a routing table that it maintains to determine a least costly path to a suitable DIA connection. In embodiments, it may be more optimal to route network traffic to other edge devices operating on the same LAN 308 in order to reduce the load on a dedicated connection between 302 and 306. Accordingly, in the case that both DIA connections DIA 2 and DIA 3 are both open, routing the network traffic to 304 to be routed through DIA 2 is more optimal than routing the network traffic to 306 to be routed through DIA 3. Hence, the edge device 302 routes the network traffic across the LAN and to the external network through DIA 2 via 304 to an external network.

FIG. 4A depicts a third block diagram illustrating exemplary network traffic routing that may occur under a third scenario. In this third scenario, the first DIA connection (DIA 1) maintained by edge device 302 as well as the second DIA connection (DIA 2) maintained by edge device 304 may be currently unavailable. Additionally, the third DIA connection (DIA 3) maintained by hub device 306 is open and available.

Upon receiving network traffic to be directed toward a receiving device, and upon detecting that DIA connection DIA 1 is currently down, edge device 302 may consult a routing table that it maintains to determine a least costly path to a suitable DIA connection. In this scenario, edge device 302 may determine that the only DIA connection available is DIA 3 and the direct path between edge device 302 and 306 is the least costly path available. Hence, the edge device 302 routes the network traffic across the dedicated connection to hub device 306 and through DIA 3 to an external network.

FIG. 4B depicts a fourth block diagram illustrating exemplary network traffic routing that may occur under a fourth scenario. In this fourth scenario, the first DIA connection (DIA 1) maintained by edge device 302 as well as the second DIA connection (DIA 2) maintained by edge device 304 may be currently unavailable while the third DIA connection (DIA 3) maintained by hub device 306 is open and available. Additionally, the direct connection between edge device 302 and 306 may be severed or otherwise currently unavailable.

Upon receiving network traffic to be directed toward a receiving device, and upon detecting that DIA connection DIA 1 is currently down, edge device 302 may consult a routing table that it maintains to determine a least costly path to a suitable DIA connection. Similar to the third scenario, in this scenario, edge device 302 may determine that the only DIA connection available is DIA 3. However, edge device 302 may also determine that the least costly path to reach DIA 3 would be to route the network traffic over to 304, which then forwards that network traffic to 306 over its own direct dedicated connection. Hence, the edge device 302 routes the network traffic across the LAN to 304, which then routes the network traffic across a dedicated connection to 306 and through DIA 3 to an external network.

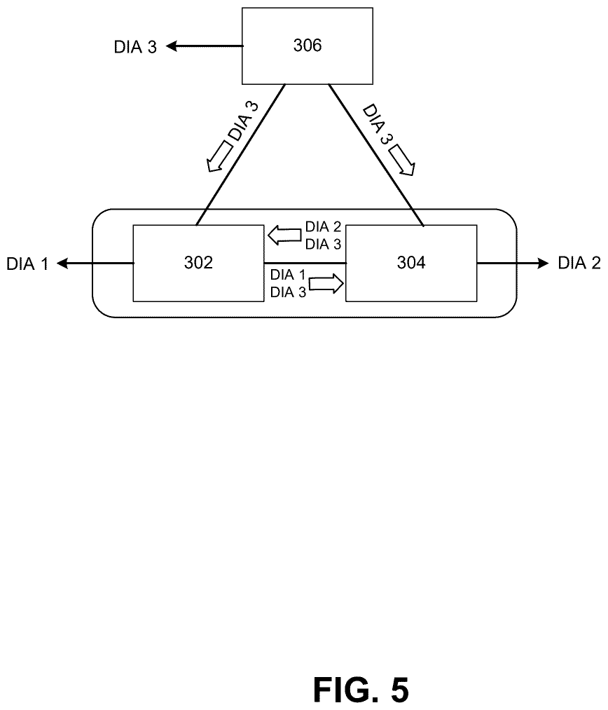

FIG. 5 depicts a block diagram illustrating techniques for sending advertisement messages between different devices in accordance with some embodiments. Similar to the above figures, FIG. 5 depicts multiple edge devices denoted as 302 and 304 operating on a LAN as well as a hub device denoted as 306. In these figures, 302 maintains a first DIA connection (DIA 1), 304 maintains a second DIA connection (DIA 2), and 306 maintains a third DIA connection (DIA 3).

As noted elsewhere, each of the devices (302, 304, and/or 306) may monitor a current status of its respective DIA connections. Upon detecting that any change in the status of its respective DIA connection has changed, each device may be configured to generate an advertisement message to be sent to at least one other device. In some cases, the device may also be configured to monitor its current connection status with another device. For example, an edge device may be configured to monitor the current status of a connection maintained between itself and a hub device operating within a SD-WAN fabric. In such cases, the edge device may be further configured to generate an advertisement message upon detecting a change in the status of that connection.

In the depicted example, when a hub device detects a change in a current status of its DIA connection, it may generate an advertisement message (e.g., using BFD protocols or any other suitable protocols) and send that advertisement message to all edge devices with which it is in communication. It should be noted that while FIG. 5 depicts edge devices 302 and 304 as operating within a single LAN, the hub device 306 may be in communication with additional edge devices (not depicted) operating on different LANs as well.

In the depicted example, when an edge device detects a change in either a current status of its DIA connection or in its connection with a hub device 306, it may generate an advertisement message. The edge device may then send that advertisement message to other edge devices operating on the same LAN. The advertisement message generated by the edge device in this scenario may include information about a detected status of the DIA connection, a detected status of the connection between itself and the hub device, and/or information included in the routing table maintained by that edge device. The edge device may transmit the generated advertisement message to all other edge devices operating on the LAN. Note that the edge device would likely not transmit the advertisement message to the hub device 306, though it may in some embodiments.

In some cases, an edge device may generate and send an advertisement message in response to receiving an advertisement message from the hub device 306. In such cases, the edge device might, upon receiving a first advertisement message from the hub device, update its own routing table based on information included in that first advertisement message and then generate a second advertisement message to be sent to the other edge devices operating on the LAN.

By way of illustration, in the example system depicted in FIG. 5, when hub device 306 detects a change in the availability of DIA 3, it generates an advertisement message that is then sent out to both of the edge devices 302 and 304. The advertisement message includes an indication of a current status of DIA 3 as detected by hub device 306.

In the illustrated example, upon receiving the advertisement message from hub device 306, each of the edge devices 302 and 304 may update a respective routing table that it maintains. Additionally, each of the edge devices 302 and 304 may individually generate a second advertisement message that is sent to the other, advertising the current status of DIA 3. Each of the edge devices may then, upon receiving the second advertisement message, update its routing table once more based on that information. In this way, each edge device is able to obtain information about alternative paths to the DIA 3 (at the hub device 306) through other edge devices.

Furthermore, in the illustrated example, upon detecting a change in status of its respective DIA connection (DIA 1 or DIA 2), each of the edge devices 302 and 304 may be configured to generate an advertisement message indicating that change in status that is then transmitted to the other respective edge device. Note that the edge device 302 and/or 304 may not transmit that advertisement message to the hub device 306. Additionally, unlike the scenario in which the edge device generates a second advertisement message in response to receiving an advertisement message from the hub device, an edge device may be configured not to send a second advertisement message when it receives an advertisement message from another edge device.

Each time that a device in the system receives an advertisement message, that device may update a routing table that it maintains locally to reflect the information included in that advertisement message. Note that each of the edge devices (e.g., 302 and 304) may independently maintain their own routing table that includes information specific to that edge device. The routing table may include information about each path to a DIA connection available for use by that edge device along with an indication of a current status of that DIA connection. The routing table may include information about multiple paths to the same DIA connection. For example, edge device 302 may maintain information related to a first path to reach DIA 3 via a direct path between itself and the hub device 306 as well as a second path to reach DIA 3 through edge device 304. In some cases, the routing table may include an indication of a cost associated with each path. It would be recognized by one skilled in the art that while each edge device may maintain a routing table, a hub device may not necessarily maintain such a routing table.

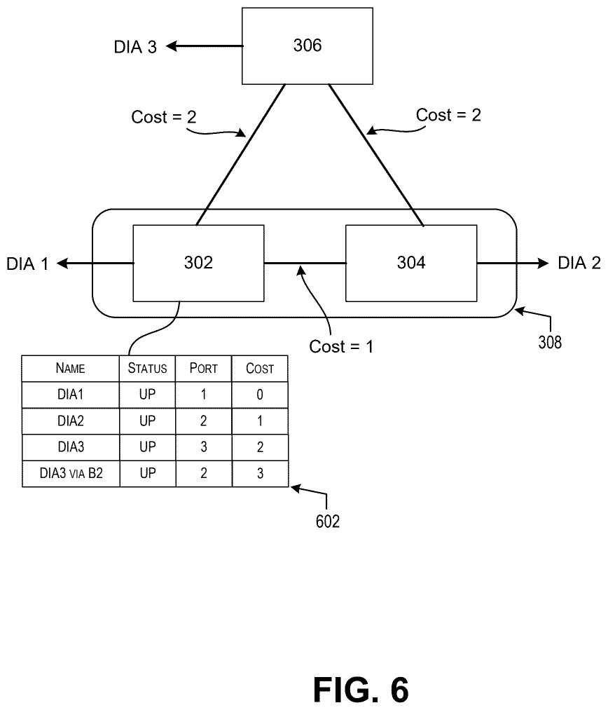

FIG. 6 depicts a block diagram illustrating implementation of a routing table that may be maintained locally by an edge device to make routing decisions in accordance with at least some embodiments. Similar to the above figures, FIG. 5 depicts multiple edge devices denoted as 302 and 304 operating on a LAN as well as a hub device denoted as 306. In these figures, edge device 302 maintains a first DIA connection (DIA 1), edge device 304 maintains a second DIA connection (DIA 2), and hub device 306 maintains a third DIA connection (DIA 3).

As described elsewhere, each edge device (e.g., 302 or 304) may maintain a routing table 602 that includes information about a number of DIA connections. The information may include an indication as to a current status of the DIA connection (e.g., whether or not the DIA connection is currently available), a path associated with the DIA connection (e.g., a port), and any other suitable information. In some cases, the routing table 602 may include information about a cost associated with a path to the DIA connection that can be used to prioritize routing by the edge device.

In embodiments, each connection between the various devices included within the system may be assigned a cost. In some embodiments, the cost assigned to a particular path may be determined based on a type of device or network connection associated with the path. For example, paths to hub devices that are reachable by a first edge device over a dedicated connection may be assigned one cost while paths to other edge devices that are reachable by the first edge device over a LAN connection may be assigned another cost. Note that generally, costs assigned to paths between edge devices operating on the same LAN are likely to be lower than costs assigned to paths between an edge device and a hub device. Additionally, while costs assigned to paths between edge devices may generally be low, they may vary. For example, a path to an edge device that has a higher load or is experiencing higher latency may be assigned a higher cost than a path to an edge device that has a lighter load or is experiencing low latency.

When an edge device receives an advertisement message from another device that relates to a DIA connection, that edge device may calculate a cost to be associated with a table entry for the DIA connection based on a sum of the costs of each path that would need to be traversed to reach the DIA connection. For example, upon receiving an advertisement message from edge device 304 that relates to DIA 3 managed by hub device 306, edge device 302 may calculate a total cost (based on the depicted example) of that path to DIA 3 as 3 (1 for the path between edge device 302 and edge device 304 plus 2 for the path between 304 and 306). In some embodiments, the entries stored in the routing table 602 may be ordered or prioritized based on their respective calculated costs.

Upon receiving network traffic that is determined to be directed toward an external network, edge device may consult the routing table 602 to identify the most optimal routing path. In this scenario, the edge device 302 may look for the DIA connection that is currently available (e.g., “UP”) that has the lowest cost. In the case that the entries in the routing table 602 are ordered based on cost (e.g., from lowest to highest), the edge device 302 can move down the table until it finds the first DIA connection/path that is indicated as being available. The edge device then routes the network traffic to the appropriate port associated with the identified DIA connection/path.

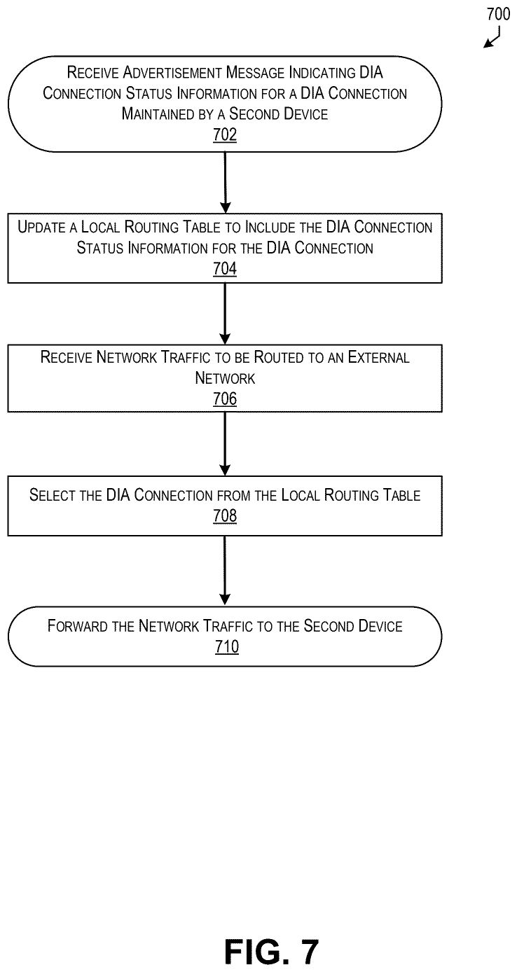

FIG. 7 depicts a flow diagram of an example method 700 to be used in optimally routing network traffic to a DIA connection in accordance with embodiments. In some examples, the steps of method 700 may be performed, at least partly, by an edge device as described herein.

As noted elsewhere, an edge device may be any suitable device that operates on the edge of a network (e.g., a LAN) to provide access (e.g., ingress and/or egress) to that network as well as to a SD-WAN fabric. In embodiments, an edge device may perform routing operations for network traffic entering and exiting the network. Particularly, the edge device may need to determine whether network traffic is to be routed over the SD-WAN fabric or instead over an external network. For network traffic for which a determination is made that it should be sent over the external network, the edge device may be configured to identify the most optimal DIA connection as described herein. Multiple edge devices may operate on any given network. Each edge device may separately maintain a local routing table as described herein.

At 702, the process/method may involve receiving an advertisement message from a second device that includes an indication of a status for at least one DIA connection. In some cases, the second device is a second edge device that is operating on the same LAN as the recipient edge device. In some cases, the second device is a hub device that is operating on the SD-WAN fabric, the hub device being reachable by the edge device over a dedicated item.

At a minimum, the advertisement message may include an indication of a current status of the DIA connection. For example, the advertisement message may include an indication as to whether a particular DIA connection is currently available or unavailable. As noted elsewhere, the advertisement message may further include an indication of a cost associated with a path associated with the DIA connection. For example, where an advertisement message is received by a first edge device from a second edge device, that advertisement message may include an indication of a status of a DIA connection maintained by a hub device in communication with the second edge device along with a cost associated with the connection between the hub device and the second edge device. As noted elsewhere, advertisement messages may be generated each time that a device detects a change in the status of its DIA connection.

At 704, the process may involve updating a local routing table (maintained by the edge device) to include the information about the DIA connection. At a minimum, the edge device updates one or more entries in the local routing table to include the information about the current status of the DIA connection. In some cases, the edge device may also calculate a cost associated with a path to each DIA connection associated with an entry in the local routing table. In some cases, the cost associated with an entry may be calculated as a sum of the costs associated with each path needed to be traversed to reach the DIA connection. For example, a cost may be determined based at least in part on a path between the first edge device and the second device, which can be added to a cost associated with any other path to be traversed. In some embodiments, entries stored in the local routing table may be ordered based on a respective cost associated with individual entries in the number of entries.

At 706, the process may involve receiving network traffic that is to be routed over the external network. As discussed elsewhere, a determination may be made that network traffic should be routed over the external network if that network traffic is not associated with, or is associated with relatively low, SLA requirements. In embodiments, the network traffic originates from a computing device operating on the LAN.

At 708, the edge device may select the DIA connection from the local routing table based on the information previously included in the routing table. In some embodiments, the selection of the at least one second DIA connection is made based at least in part on a respective cost associated with the DIA connection in the local routing table. Upon selection of the DIA connection, the edge device may forward the network traffic to the second device at 710.

In some embodiments, an edge device is further configured to generate an advertisement message upon receiving another advertisement message from a hub device. For example, a first edge device may receive an advertisement message from a hub device that indicates an availability of the DIA connection maintained by that hub device. In this scenario, the first edge device may generate a second advertisement message that is sent to other edge devices operating on the same LAN. A second edge device that receives the second advertisement message may update its local routing table to include the information about the availability of the DIA connection maintained by the hub device. In such cases, the local routing table may include an indication that the second DIA connection is accessible through the first edge device.

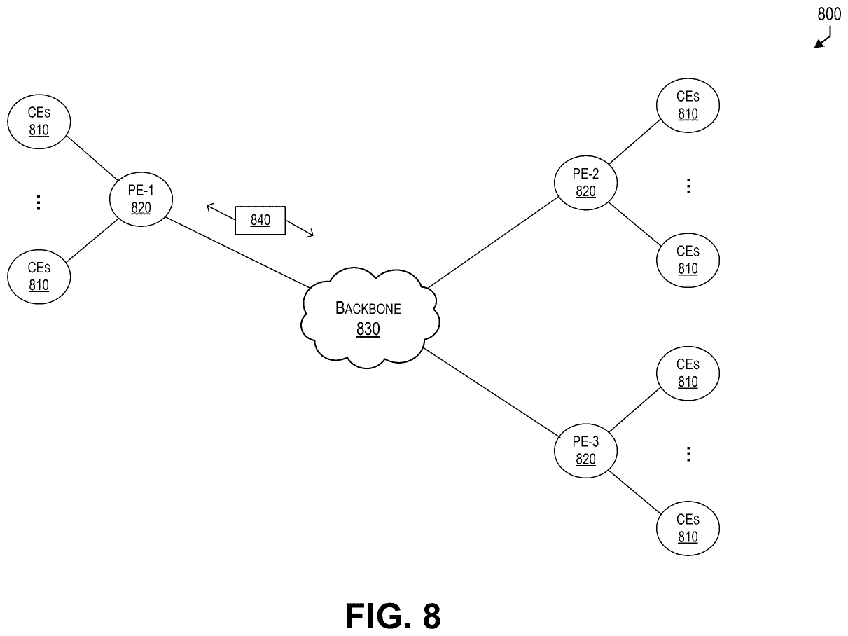

FIG. 8 is a schematic block diagram of an example computer network 800 illustratively comprising nodes/devices, such as a plurality of routers/devices interconnected by links or networks, as shown. A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANS). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to pre-defined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

In the depicted example, customer edge (CE) routers 810 may be interconnected with provider edge (PE) routers 820 (e.g., PE-1, PE-2, and PE-3) in order to communicate across a core network, such as an illustrative network as backbone 830. For example, routers 810, 820 may be interconnected by the public Internet, a multiprotocol label switching (MPLS) virtual private network (VPN), or the like. Data packets 840 (e.g., traffic/messages) may be exchanged among the nodes/devices of the computer network 800 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 810 shown in network 800 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected is to network 800 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2, or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 810 connected to PE-2 and a second CE router 810 connected to PE-3.

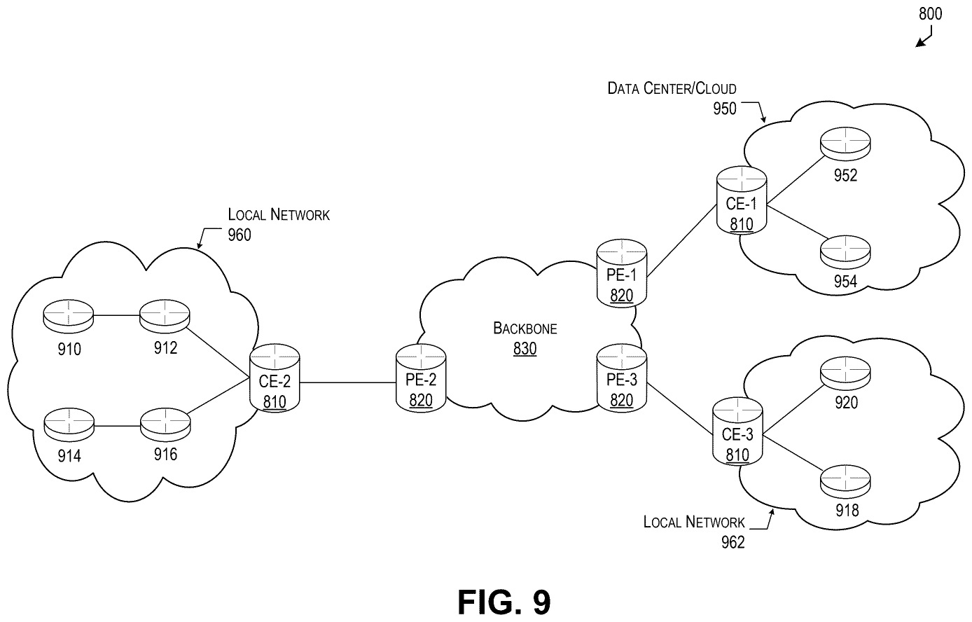

FIG. 9 illustrates an example of network 800 in greater detail, according to various embodiments. As shown, network backbone 830 may provide connectivity between devices located in different geographical areas and/or different types of local networks. For example, network 800 may comprise local/branch networks 960, 962 that include devices/nodes 910-916 and devices/nodes 918-920, respectively, as well as a data center/cloud environment 950 that includes servers 952-954. Notably, local networks 960-962 and data center/cloud environment 950 may be located in different geographic locations.

Servers 952-954 may include, in various embodiments, a network management server (NMS), a dynamic host configuration protocol (DHCP) server, a constrained application protocol (COAP) server, an outage management system (OMS), an application policy infrastructure controller (APIC), an application server, etc. As would be appreciated, network 800 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software defined WAN (SD-WAN) may be used in network 800 to connect local network 960, local network 962, and data center/cloud environment 950. In general, an SD-WAN uses a software defined networking (SDN)-based approach to instantiate tunnels on top of the physical network and control routing decisions, accordingly. For example, as noted above, one tunnel may connect router CE-2 at the edge of local network 960 to router CE-1 at the edge of data center/cloud environment 950 over an MPLS or Internet-based service provider network in backbone 830. Similarly, a second tunnel may also connect these routers over a 4G/5G/LTE cellular service provider network. SD-WAN techniques allow the WAN functions to be virtualized, essentially forming a virtual connection between local network 960 and data center/cloud environment 950 on top of the various underlying connections. Another feature of SD-WAN is centralized management by a supervisory service that can monitor and adjust the various connections, as needed.

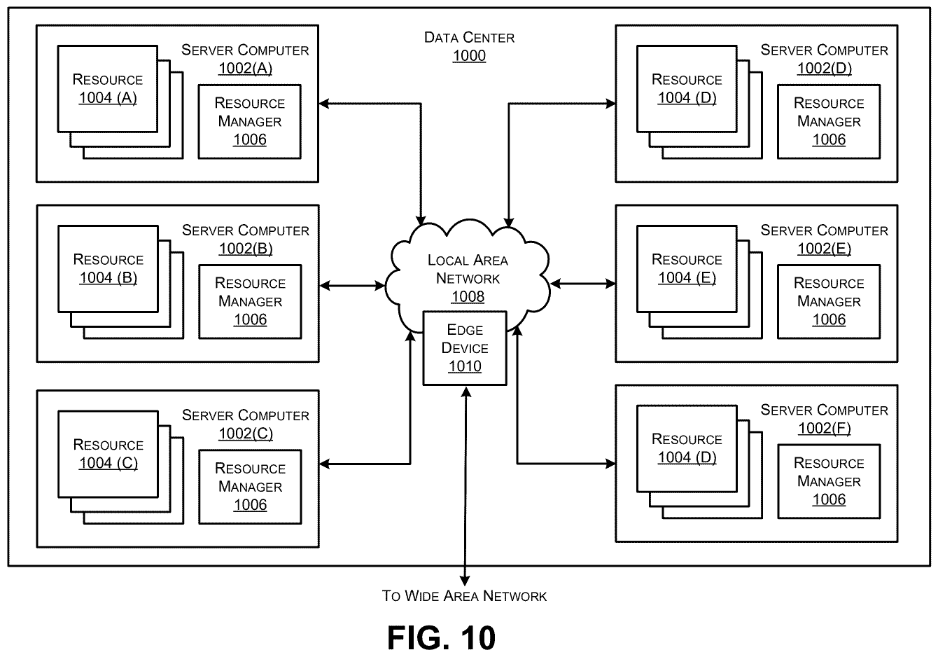

FIG. 10 is a computing system diagram illustrating a configuration for a data center 1000 that can be utilized to implement aspects of the technologies disclosed herein. The example data center 1000 shown in FIG. 10 includes several server computers 1002A-1002F (which might be referred to herein singularly as “a server computer 1002” or in the plural as “the server computers 1002”) for providing computing resources. In some examples, the resources and/or server computers 1002 may include, or correspond to, the any type of networked device described herein. Although described as servers, the server computers 1002 may comprise any type of networked device, such as servers, switches, routers, hubs, bridges, gateways, modems, repeaters, access points, etc.

The server computers 1002 can be standard tower, rack-mount, or blade server computers configured appropriately for providing computing resources. In some examples, the server computers 1002 may provide computing resources 1004 including data processing resources such as VM instances or hardware computing systems, database clusters, computing clusters, storage clusters, data storage resources, database resources, networking resources, and others. Some of the server computers 1002 can also be configured to execute a resource manager 1006 capable of instantiating and/or managing the computing resources. In the case of VM instances, for example, the resource manager 1006 can be a hypervisor or another type of program configured to enable the execution of multiple VM instances on a single server computer 1002. Server computers 1002 in the data center 1000 can also be configured to provide network services and other types of services.

In the example data center 1000 shown in FIG. 10, an appropriate network 1008 (e.g., LAN) is also utilized to interconnect the server computers 1002A-1002F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 1000, between each of the server computers 1002A-1002F in each data center 1000, and, potentially, between computing resources in each of the server computers 1002. It should be appreciated that the configuration of the data center 1000 described with reference to FIG. 10 is merely illustrative and that other implementations can be utilized.

In some examples, the server computers 1002 may each execute one or more application containers and/or virtual machines to perform techniques described herein.

In some instances, the data center 1000 may provide computing resources, like application containers, VM instances, and storage, on a permanent or an as-needed basis. Among other types of functionality, the computing resources provided by a cloud computing network may be utilized to implement the various services and techniques described above. The computing resources 1004 provided by the cloud computing network can include various types of computing resources, such as data processing resources like application containers and VM instances, data storage resources, networking resources, data communication resources, network services, and the like.

Each type of computing resource 1004 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 1004 not mentioned specifically herein.

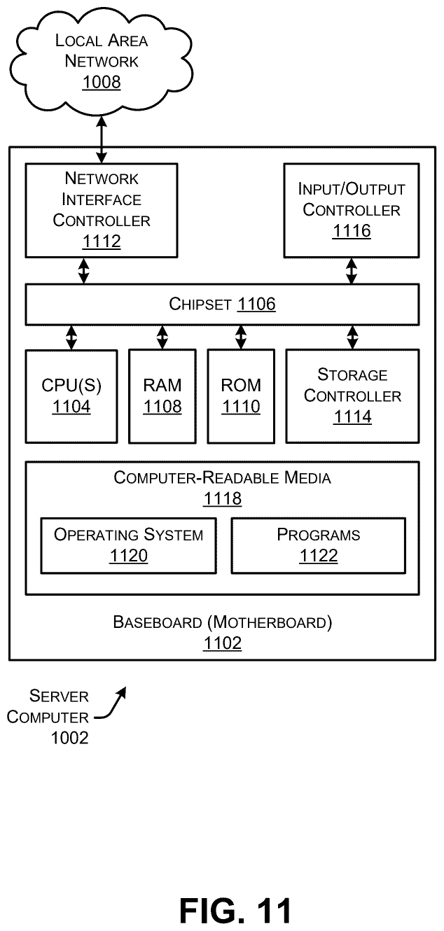

The computing resources 1004 provided by a cloud computing network may be enabled in one embodiment by one or more data centers 1000 (which might be referred to herein singularly as “a data center 1000” or in the plural as “the data centers 1000”). The data centers 1000 are facilities utilized to house and operate computer systems and associated components. The data centers 1000 typically include redundant and backup power, communications, cooling, and security systems. The data centers 1000 can also be located in geographically disparate locations. One illustrative embodiment for a data center 1000 that can be utilized to implement the technologies disclosed herein will be described below with regard to FIG. 11.

The network 1008 may be configured to enable connectivity between the server computers 1002(A-F) and an external wide area network (WAN). In some embodiments, this is accomplished via an edge device 1010 in communication with the network 1008. Such an edge device 1010 may use any suitable routing protocols to route communications between the various components depicted.

FIG. 11 shows an example computer architecture for a server computer 1002 capable of executing program components for implementing the functionality described above. The computer architecture shown in FIG. 11 illustrates a conventional server computer, workstation, desktop computer, laptop, tablet, network appliance, e-reader, smartphone, or other computing device, and can be utilized to execute any of the software components presented herein. The server computer 1002 may, in some examples, correspond to a physical server as described herein, and may comprise networked devices such as servers, switches, routers, hubs, bridges, gateways, modems, repeaters, access points, etc.

The server computer 1002 includes a baseboard 1102, or “motherboard,” which is a printed circuit board to which a multitude of components or devices can be connected by way of a system bus or other electrical communication paths. In one illustrative configuration, one or more central processing units (“CPUs”) 1104 operate in conjunction with a chipset 1106. The CPUs 1104 can be standard programmable processors that perform arithmetic and logical operations necessary for the operation of the server computer 1002.

The CPUs 1104 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 1106 provides an interface between the CPUs 1104 and the remainder of the components and devices on the baseboard 1102. The chipset 1106 can provide an interface to a RAM 1108, used as the main memory in the computer 1002. The chipset 1106 can further provide an interface to a computer-readable storage medium such as a read-only memory (“ROM”) 1110 or non-volatile RAM (“NVRAM”) for storing basic routines that help to startup the computer 1002 and to transfer information between the various components and devices. The ROM 1110 or NVRAM can also store other software components necessary for the operation of the computer 1002 in accordance with the configurations described herein.

The computer 1002 can operate in a networked environment using logical connections to remote computing devices and computer systems through a network, such as the network 1008. The chipset 1106 can include functionality for providing network connectivity through a NIC 1112, such as a gigabit Ethernet adapter. The NIC 1112 is capable of connecting the computer 1002 to other computing devices over the network 1008 (and/or 102). It should be appreciated that multiple NICs 1112 can be present in the computer 1002, connecting the computer to other types of networks and remote computer systems.

The computer 1002 can be connected to a storage device 1118 that provides non-volatile storage for the computer. The storage device 1118 can store an operating system 1120, programs 1122, and data, which have been described in greater detail herein. The storage device 1118 can be connected to the computer 1002 through a storage controller 1114 connected to the chipset 1106. The storage device 1118 can consist of one or more physical storage units. The storage controller 1114 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 1002 can store data on the storage device 1118 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 1118 is characterized as primary or secondary storage, and the like.

For example, the computer 1002 can store information to the storage device 1118 by issuing instructions through the storage controller 1114 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 1002 can further read information from the storage device 1118 by detecting the physical states or characteristics of one or more particular locations within the physical storage units.

In addition to the mass storage device 1118 described above, the computer 1002 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 1002. In some examples, the operations performed by devices as described herein may be supported by one or more devices similar to computer 1002. Stated otherwise, some or all of the operations performed by the edge device 106, and/or any components included therein, may be performed by one or more server computers 1002 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 1118 can store an operating system 1120 utilized to control the operation of the computer 1002. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 1118 can store other system or application programs and data utilized by the computer 1002.

In one embodiment, the storage device 1118 or other computer-readable storage media is encoded with computer-executable instructions which, when loaded into the computer 1002, transform the computer from a general-purpose computing system into a special-purpose computer capable of implementing the embodiments described herein. These computer-executable instructions transform the computer 1002 by specifying how the CPUs 1104 transition between states, as described above. According to one embodiment, the computer 1002 has access to computer-readable storage media storing computer-executable instructions which, when executed by the computer 1002, perform the various processes described above with regard to FIGS. 1-7. The computer 1002 can also include computer-readable storage media having instructions stored thereupon for performing any of the other computer-implemented operations described herein.

The computer 1002 can also include one or more input/output controllers 1116 for receiving and processing input from a number of input devices, such as a keyboard, a mouse, a touchpad, a touch screen, an electronic stylus, or other type of input device. Similarly, an input/output controller 1116 can provide output to a display, such as a computer monitor, a flat-panel display, a digital projector, a printer, or other type of output device. It will be appreciated that the computer 1002 might not include all of the components shown in FIG. 11, can include other components that are not explicitly shown in FIG. 8, or might utilize an architecture completely different than that shown in FIG. 11.

As described herein, the computer 1002 may include one or more hardware processors (e.g., CPU 1104) configured to execute one or more stored instructions. The processor(s) may comprise one or more cores. Further, the computer 1002 may include one or more network interfaces configured to provide communications between the computer 1002 and other devices, such as the communications described herein as being performed by the edge device 106. The network interfaces may include devices configured to couple to personal area networks (PANs), wired and wireless local area networks (LANs), wired and wireless wide area networks (WANs), and so forth. More specifically, the network interfaces include the mechanical, electrical, and signaling circuitry for communicating data over physical links coupled to the network 800. The network interfaces may be configured to transmit and/or receive data using a variety of different communication protocols. Notably, a physical network interface may also be used to implement one or more virtual network interfaces, such as for virtual private network (VPN) access, known to those skilled in the art. In one example, the network interfaces may include devices compatible with Ethernet, Wi-Fi™, and so forth.

The programs 1122 may comprise any type of programs or processes to perform the techniques described in this disclosure. The programs 1122 may comprise any type of program that cause the computer 1002 to perform techniques for communicating with other devices using any type of protocol or standard usable for determining connectivity. These software processors and/or services may comprise a routing module and/or a Path Evaluation (PE) Module, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, routing module contains computer executable instructions executed by the processor to perform functions provided by one or more routing protocols. These functions may, on capable devices, be configured to manage a routing/forwarding table (a data structure) containing, e.g., data used to make routing forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (i.e., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, routing module may implement a process that consists solely of providing mechanisms necessary for source routing techniques. That is, for source routing, other devices in the network can tell the less capable devices exactly where to send the packets, and the less capable devices simply forward the packets as directed.

In various embodiments, as detailed further below, PE Module may also include computer executable instructions that, when executed by processor(s), cause server computer 1002 to perform the techniques described herein. To do so, in some embodiments, PE Module may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a* x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, PE Module may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as normal or anomalous. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that path evaluation process can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted an undesirable behavior of a path, such as its delay, packet loss, and/or jitter exceeding one or more thresholds. Conversely, the false negatives of the model may refer to the number of times the model incorrectly predicted acceptable path behavior. True negatives and positives may refer to the number of times the model correctly predicted whether the behavior of the path will be acceptable or unacceptable, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANS (SD-WANs), traffic between individual sites is sent over tunnels. The tunnels are configured to use different switching fabrics, such as MPLS, Internet, 4G or 5G, etc. Often, the different switching fabrics provide different quality of service (QoS) at varied costs. For example, an MPLS fabric typically provides high QoS when compared to the Internet but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfied, based on the switching fabric that it uses. During runtime, the SD-WAN edge router then maps the application traffic to an appropriate tunnel.

The emergence of infrastructure as a service (IaaS) and software as a service (SaaS) is having a dramatic impact of the overall Internet due to the extreme virtualization of services and shift of traffic load in many large enterprises. Consequently, a branch office or a campus can trigger massive loads on the network.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, at a first edge device that maintains a first DIA connection, an advertisement message from a second device, the advertisement message including information about a current status of at least one second Direct Internet Access (DIA) connection accessible from the second device;
updating, by the first edge device, a local routing table to include the information about the current status of the at least one second DIA connection;
receiving, by the first edge device, network traffic to be routed over an external network;
upon determining that the first DIA connection is unavailable, selecting, by the first edge device, the at least one second DIA connection based on the information in the local routing table; and
forwarding, by the first edge device, the network traffic to the second device.

2. The method of claim 1, wherein the second device comprises a second edge device operating on a Local Access Network (LAN) that the first edge device is operating on.

3. The method of claim 1, wherein the second device comprises a hub device operating within a SD-WAN fabric.

4. The method of claim 1, further comprising determining a cost associated with the at least one second DIA connection, wherein the selecting the at least one second DIA connection is based at least in part on the cost.

5. The method of claim 4, wherein the cost is determined based at least in part on a path between the first edge device and the second device.

6. The method of claim 4, wherein the local routing table comprises a number of entries, individual entries associated with a DIA connection.

7. The method of claim 6, wherein a number of entries stored in the local routing table are ordered based on a respective cost associated with individual entries in the number of entries.

8. An edge device comprising:
one or more processors; and
one or more non-transitory computer-readable media storing computer-executable instructions that, when executed by the one or more processors, cause the edge device to perform operations comprising:
receiving an advertisement message from a second device, the advertisement message including information about a current status of at least one second Direct Internet Access (DIA) connection accessible from the second device;
updating a local routing table to include the information about the current status of the at least one second DIA connection;
receiving network traffic to be routed over an external network;
upon determining that a first DIA connection maintained by the edge device is unavailable, selecting the at least one second DIA connection based on the information in the local routing table; and
forwarding the network traffic to the second device.

9. The edge device of claim 8, wherein the edge device provides ingress/egress to a Local Area Network (LAN).

10. The edge device of claim 9, wherein the network traffic originates from a computing device operating on the LAN.

11. The edge device of claim 9, wherein the second device comprises a second edge device operating on the LAN.

12. The edge device of claim 8, wherein the information about the current status comprises an indication as to whether the DIA connection is available or unavailable.

13. The edge device of claim 8, wherein the external network comprises the Internet.

14. The edge device of claim 8, further comprising determining a cost associated with the at least one second DIA connection, wherein the selecting the at least one second DIA connection is based at least in part on the cost.

15. The edge device of claim 14, wherein the cost is determined based at least in part on a path between the first edge device and the second device.

16. The edge device of claim 14, wherein the local routing table comprises a number of entries, individual entries associated with a DIA connection.

17. A system comprising:
a first edge device configured to:
monitor a current status of a Direct Internet Access (DIA) connection; and
upon detecting a change in the current status of the DIA connection, provide an advertisement message to a second edge device that includes information about the current status; and
the second edge device configured to:
receive the advertisement message from the first edge device;
update a local routing table to include the information about the current status;
upon receiving network traffic directed to an external network, select the DIA connection based on the local routing table; and
route the network traffic to the first edge device.

18. The system of claim 17, wherein both the first edge device and the second edge device are operating on a Local Area Network (LAN).

19. The system of claim 17, wherein the first edge device is further configured to:
receive a second advertisement message from a hub device, the second advertisement message including information about a status of a second DIA connection maintained by the hub device; and
provide a third advertisement message to the second edge device that includes the information about the status of the second DIA connection.

20. The system of claim 19, wherein the second edge device is further configured to:
receive the third advertisement message from the first edge device; and
update the local routing table to include the information about the status of the second DIA connection, wherein the local routing table indicates that the second DIA connection is accessible through the first edge device.
